(19) United States
(12) Patent Application Publication
(10) Pub. No.: US 2003/0153266 A1
(43) Pub. Date: Aug. 14, 2003

(54) Wireless interchange apparatus for mobile communication system

(76) Inventors: Chon Won Kim, Jangan-gu (KR); Hyun Rok Lee, Bukbyon-Dong (KR)

Correspondence Address: Harness Dickey & Pierce, P O Box 828, Bloomfield Hills, MI, 48303, US

(21) Appl. No.: 10/296,752

(22) PCT Filed: May 31, 2002
(86) PCT No.: PCT/KR02/01033

(30) Foreign Application Priority Data
Jun. 1, 2001 (KR) 2001/30882

(51) Int. Cl. H04B 1/10; H04B 7/15

(52) U.S. Cl. 455/11.1; 455/311

(57) ABSTRACT

Disclosed herein is a wireless repeating apparatus for mobile communication system. The present invention relates generally to a wireless repeating apparatus for repeating a signal at the same frequency as that of a wirelessly received signal in a mobile communication system. The present invention relates more particularly to a wireless repeating apparatus for mobile communication, which detects an amplitude and a phase of a wirelessly received signal and synthesizes the detected results to generate inverse phases in multiple stages, thus enabling interference signals to be eliminated, and enabling the repeating apparatus to be used over a open area using the elimination of the interference signals.

### BACKGROUND OF THE INVENTION

1. Field of the Invention

The present invention relates generally to a wireless repeating apparatus for repeating a signal at the same frequency as that of a wirelessly received signal in a mobile communication system, and more particularly to a wireless repeating apparatus for mobile communication, which detects an amplitude and a phase of a wirelessly received signal and synthesizes the detected results to generate inverse phases in multiple stages, thus enabling interference signals to be eliminated, and enabling the repeating apparatus to be used over a open area using the elimination of the interference signals.

2. Description of the Related Art

Generally, a repeating apparatus is used in a mobile communication system so as to overcome a shadow area for radio frequency (RF) waves. The repeating apparatus performs functions of receiving and amplifying weak RF waves and then retransmitting the amplified signals. For these functions, the repeating apparatus requires additional receiving and transmitting antennas.

When the same frequency is transmitted through such a repeating apparatus, a strong transmitting signal is added to an original weak reception signal if the strong transmitting signal is inputted to the receiving antenna, thus preventing the repeating apparatus from operating normally. That is, of signals inputted through the receiving antenna, the transmitting signal inputted by transmitting signal amplification of the repeating apparatus itself is reamplified, thus causing problems such as oscillation of the repeating apparatus, devices failure, etc.

In a conventional repeating apparatus for solving the problems, there is used a method of maintaining a predetermined distance between transmitting and receiving antennas, for example, a vertical spacing distance of almost 10 m, or a horizontal spacing distance of almost 100 m. Alternatively, there is used a method of reducing a transmission signal and then suppressing feedback interference to be suppressed by using a ground or an earth between the transmitting and receiving antennas.

However, such a conventional repeating apparatus is problematic in its construction, in that it is very expensive to install transmitting and receiving antennas so as to minimize a feedback interference phenomenon. Further, as antenna mounting structures become huge, application fields of the repeating apparatus are limited, so it is very difficult to practically utilize the repeating apparatus.

Meanwhile, there my be implemented a repeating apparatus in which transmitting and receiving antennas are arranged to be close to each other(2˜3m),and an interference eliminating circuit for eliminating feedback interference signals received through a receiving antenna is installed within the repeating apparatus to suppress interference signals, thus enabling a repeating operation.

However, current technologies for implementing the interference eliminating circuit are interference eliminating technologies using time-domain signal processing, which are already utilized and used in domestic and overseas areas. However, since the technologies have narrow-band characteristics, it is very difficult to implement a repeating apparatus by applying the above technologies to a code division multiple access (CDMA) cellular mobile communication network or a personal communication system (PCS) mobile communication network (requiring a bandwidth equal to or greater than 1.25 MHz), B-WLL (requiring a bandwidth equal to or greater than 8 MHz) and a later IMT-2000 service network (requiring a bandwidth equal to or greater than 5 MHz) which require wide band characteristics.

### SUMMARY OF THE INVENTION

Accordingly, the present invention has been made keeping in mind the above problems occurring in the prior art, and an object of the present invention is to provide a wireless repeating apparatus for a mobile communication network system, which can maximize an interference signal eliminating ability by additionally installing an interference eliminating circuit within a repeating apparatus for a cellular or PCS mobile communication network, or by connecting the repeating apparatus to another interference eliminating circuit.

Another object of the present invention is to provide a wireless repeating apparatus for a mobile communication network system, which can provide a repeating service to a open area, as well as underground or inside buildings, and can also be applied to a later wide-band mobile communication network.

A further object of the present invention is to provide a wireless repeating apparatus, which can enable a repeating apparatus for wide-band mobile communication networks (cellular, personal communication system, IMT-2000) to be effectively used for open area services and indoor services.

In order to accomplish the above objects, the present invention provides a repeating apparatus of a wide-band mobile communication system, the repeating apparatus amplifying a relessly received signal and repeating the amplified signal at the same frequency as that of the received signal, comprising a transmission stage comprised of first specific tone generating means for generating a specific tone signal for a wireless repeating operation of a signal at the same frequency, first amplifying means for amplifying the specific tone signal outputted from the first specific tone generating means, first filtering means for filtering, duplexing and radiating the specific tone signal amplified by the first amplifying means, and first phase and amplitude detecting means for detecting an amplitude and a phase variation of a signal radiated and induced by the first filtering means; and a reception stage comprised of second filtering means for receiving, filtering and duplexing the specific tone signal radiated from the transmission stage, second amplifying means for amplifying the specific tone signal outputted from the second filtering means, second phase and amplitude detecting means for detecting an amplitude and a phase variation of the specific tone signal outputted from the second amplifying means, phase and amplitude comparing means for comparing and detecting the phase and amplitude outputted from the first phase and amplitude detecting means with those outputted from the second phase and amplitude detecting means, control means for controlling and transmitting information detected by the phase and amplitude comparing means, amplitude and inverse phase amplitude means for summation amplitudes and inverse phases of the phase variations detected by the phase and amplitude comparing means under the control of the control means, specific tone detecting means for detecting only a specific tone component detected by the second phase and amplitude detecting means, and RF switching means for monitoring an output of power under the control of the control means, and shutting off a frequency path if the output of power greater than a predetermined level is detected.

Preferably, the repeating apparatus further comprises step attenuation and feedback path means for eliminating the specific tone signal by using correction values of an amplitude and a phase of a signal internally fed back through the first phase and amplitude detecting means and a feedback path.

More preferably, the amplitude and inverse phase summation means of the present invention comprises a N-stage divider for dividing the amplitude and the phase of a signal outputted from the step attenuation and feedback path means into N-stages; a first stage amplitude and inverse phase summation unit for summation an amplitude and an inverse phase of the specific tone signal of a first stage divided by the N-stage divider; a N-th stage amplitude and inverse phase summation unit for summation amplitudes and inverse phases of first to N-th stages divided by the N-stage divider; and a N-stage phase summation unit for extracting and summation phases of a first stage and a N-th stage.

### BRIEF DESCRIOPION OF THE DRAWINGS

The above and other objects, features and other advantages of the present invention will be more clearly understood from the following detailed description taken in conjunction with the accompanying drawings, in which:

FIG. 1 is a block diagram of a wireless repeating apparatus linked in a forward direction according to the present invention;

FIG. 2 is a flowchart showing an algorithm performed by the wireless repeating apparatus before the wireless repeating apparatus is normally operated according to the present invention; and

FIG. 3 is a flowchart showing an algorithm performed by the wireless repeating apparatus when the wireless repeating apparatus is normally operated according to the present invention.

### DETAILED DESCRIPTION OF THE EMBODIMENTS

In a repeating apparatus of the present invention, a forward direction link represents a case of receiving RF signals from a base station, amplifying the RF signals to desired signals, and radiating the amplified signals to a shadow area where a repeating service is to be provided. On the contrary, a backward direction link represents a case of receiving weak RF signals of a mobile station, amplifying the weak RF signals to desirous signals, and transmitting the amplified signals to the base station. In the latter case, the same apparatus as that of the forward direction link is required.

That is, two identical apparatuses are required to be installed within one repeater. In the present invention, since an apparatus in the backward direction link uses the same operating principles as those of the forward direction link, only the operating principles in the forward direction link are described in detail.

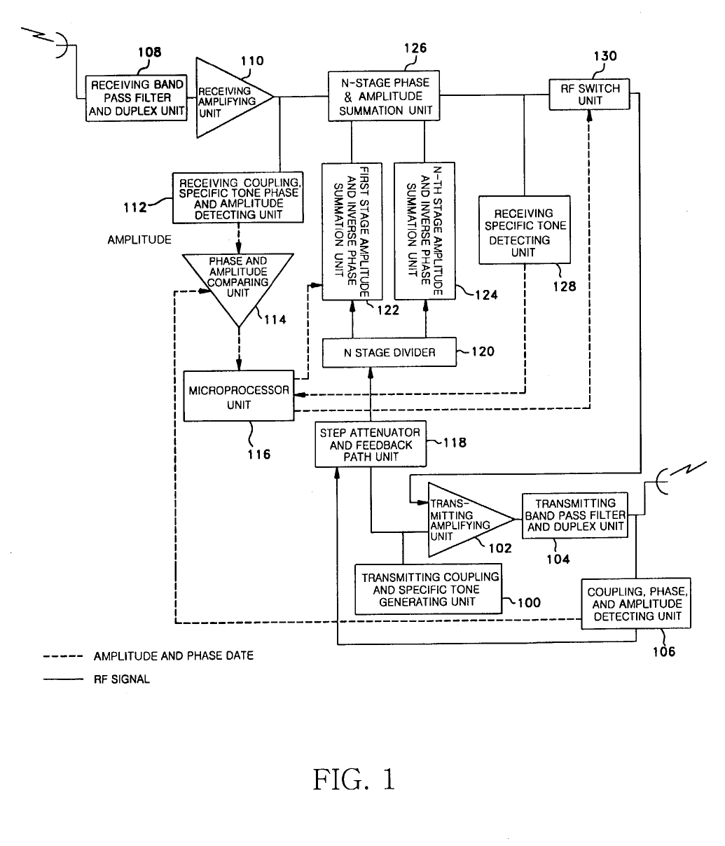

FIG. 1 is a block diagram of a wireless repeating apparatus linked in a forward direction according to the present invention.

Referring to FIG. 1, a transmission stage comprises a transmission coupling and specific tone generating unit 100; a transmission amplifying unit 102; a transmission band pass filter (BPF) and duplex unit 104; and a coupling, phase, and amplitude detecting unit 106.

In this case, the coupling and specific tone generating unit 100 is connected to an input stage of the transmission amplifying unit 102. The coupling, phase, and amplitude detecting unit 106 is connected to an output stage of the transmission amplifying unit 102.

A reception stage comprises a reception band pass filter and duplex unit 108; a reception amplifying unit 110; a reception coupling and specific tone phase and amplitude detecting unit 112; a phase and amplitude comparing unit 114; a microprocessor unit 116; a step attenuator and feedback path unit 118 for internal feedback signals; a N-stage divider 120; a first stage amplitude and inverse phase summation unit 122; a N-th stage amplitude and inverse phase summation unit 124; a N-stage phase summation unit 126; a reception specific tone detecting unit 128; and an RF switch unit 130.

In this case, the coupling, specific tone phase and amplitude detecting unit 112 is connected to an output stage of the reception amplifying unit 110.

Hereinafter, the operations of respective components of the wireless repeating apparatus of the present invention are described in detail.

First, before the wireless repeating apparatus is normally driven, the coupling and specific tone generating unit 100 is connected to the input stage of the transmission amplifying unit 102 of the repeating apparatus. A specific tone signal outputted from the coupling and specific tone generating unit 100 is inputted to a forward direction amplifier of the repeating apparatus, that is, the band pass filter and duplex unit 104, and then radiated to space through a transmitting antenna.

Further, when the specific tone RF signal radiated to space is induced in a receiving antenna and received, the received RF signal is amplified by the reception amplifying unit 110, and then applied to the N-stage phase summation unit 126 which is an original signal path.

In this case, the amplitude and phase variation of the RF signal radiated to space and induced in the receiving antenna are detected by the reception coupling, specific tone phase and amplitude detecting unit 112 in a stage previous to the N-stage phase summation unit 126. The phase and amplitude comparing unit 114 compares values detected by the reception coupling, specific tone phase and amplitude detecting unit 112 with values detected by the coupling, phase, and amplitude detecting unit 106. The compared information is transmitted to the microprocessor unit 116.

Then, the microprocessor unit 116 transmits the amplitude and phase variation information to both the coupling, phase, and amplitude detecting unit 106 and the first stage amplitude and inverse phase summation unit 122. Then, a signal internally fed back through the coupling, phase, and amplitude detecting unit 106 and a feedback path, passes through the step attenuator and feedback path unit 118 to which correction values of an amplitude and a phase are suitably applied, and the N-stage divider 120, thus enabling the specific tone signal to be eliminated.

The reception specific tone detecting unit 128 monitors existence of a specific tone signal, and transmits information to the microprocessor unit 116 to finish previous operations if the specific tone signal is attenuated to be lower than a predetermined level.

In this case, if a wide band service is provided, frequencies to be provided are temporarily generated, such that amplitude and phase correction values in respective frequency domains are repeatedly derived according to frequency bands using the above method. That is, the reception specific tone detecting unit 128 can be used to detect only a specific tone component by using the coupling, specific tone phase and amplitude detecting unit 112.

Further, when the repeating apparatus is normally driven, the operations of the coupling and specific tone generating unit 100, the reception coupling, specific tone phase and amplitude detecting unit 112 and the phase and amplitude comparing unit 114, which are related to the tone generation and detection, are stopped. The first stage amplitude and inverse phase summation unit 122 and the N-stage phase summation unit 126 eliminate interference signals by using only optimized and derived phase and amplitude correction values.

In this case, desired signals from the base station are outputted through the N-stage phase summation unit 126 while undergoing minimized signal attenuation. Then, the signal from which the interference signals are eliminated is directly applied to the transmission amplifying unit 102 of the repeating apparatus and amplified, such that the amplified signal is radiated to a shadow area through the transmitting antenna.

Through the above process, interference signals are continuously eliminated using optimal values for frequency, amplitude in space, and phase variation, so the repeating apparatus can provide a repeating service without an oscillation and RF devices failure phenomenon.

In this case, the coupling, phase, and amplitude detecting unit 106 continuously performs an output monitoring operation. If an output signal greater than a predetermined level is detected (when over power is outputted), the microprocessor unit 116 generates an alarm and shuts off a signal path using the RF switch 130. Further, the initializing operation performed before the repeating apparatus is normally operated is performed.

Further, when the repeating apparatus is realized, the transmission coupling and specific tone generating unit 100, the reception coupling, specific tone phase and amplitude detecting unit 112 and the phase and amplitude comparing unit 114 can be designed separately from a repeater reception stage comprised of the microprocessor unit 116, the step attenuator and feedback path unit 118, the N-stage divider 120, the first stage amplitude and inverse phase summation unit 122, the N-th stage amplitude and inverse phase summation unit 124, the N-stage phase summation unit 126, the reception specific tone detecting unit 128 and the RF switch unit 130.

Therefore, the components 100, 112 and 114 are used only when the repeating apparatus is installed. Commonly, although only the repeater reception stage circuit comprised of components 116 to 130 is used, the repeating service can be provided.

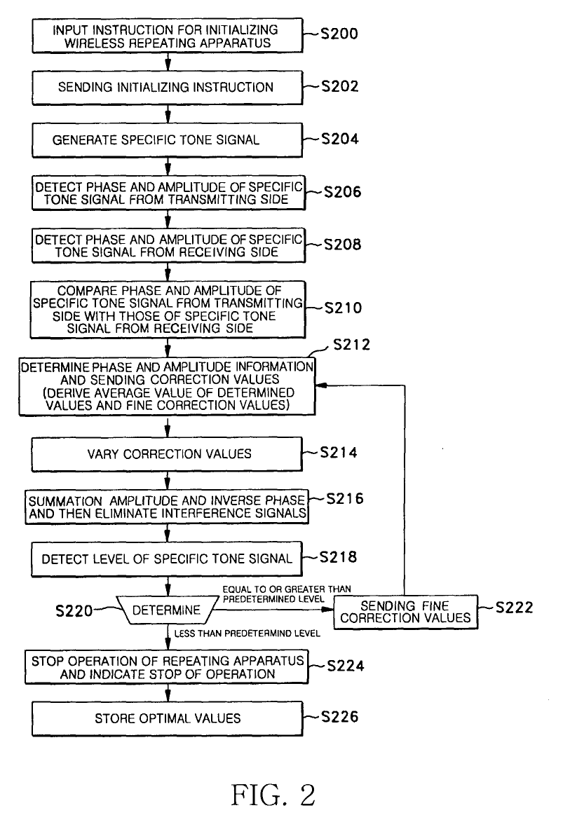

FIG. 2 is a flowchart showing an algorithm performed before the wireless repeating apparatus of the present invention is normally operated.

The algorithm comprises the steps of:

inputting an instruction for initializing the wireless repeating apparatus (S200);

transmitting the initializing instruction (S202);

generating a specific tone signal by a transmitting side (S204);

detecting the phase and amplitude of the specific tone signal from the transmitting side (S206);

detecting the phase and amplitude of a specific tone signal from a receiving side (S208);

comparing the phase and amplitude of the specific tone signal from the transmitting side with those of the specific tone signal from the receiving side (S210);

determining phase and amplitude information of the specific tone signals compared and detected, and transmitting correction values (S212);

varying the correction values (S214);

summation the amplitude and an inverse phase of the specific tone signal from the receiving side by using the correction values, and then eliminating interference signals (S216);

detecting the level of the specific tone signal from the side in which the interference signals are eliminated (S218);

determining the detected level of the specific tone signal (S220);

transmitting fine correction values if the detected level is equal to or greater than a predetermined level (S222);

stopping the operation of the repeating apparatus and indicating the stop of the operation if the detected level is less than the predetermined level (S224); and

storing final optimal values (S226).

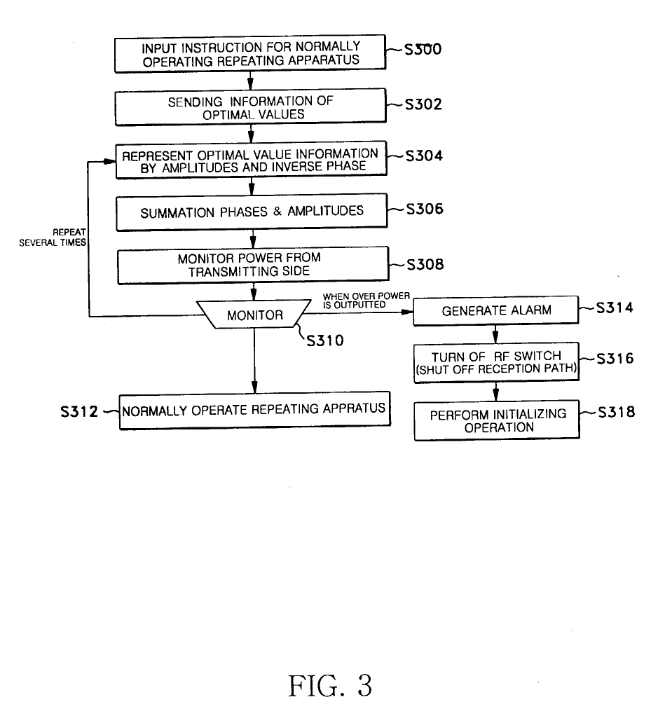

FIG. 3 is a flowchart showing an algorithm performed when the wireless repeating apparatus is normally operated. The algorithm comprises the steps of:

inputting an instruction for normally operating the wireless repeating apparatus (S300);

transmitting information of the optimal values obtained before the wireless repeating apparatus is operated (S302);

representing the optimal value information by amplitudes and inverse phases (S304);

summation phases (S306);

monitoring power from the transmitting side (S308)

normally operating the repeating apparatus if it is determined that the power is suitable according to the monitoring result (S310, S312);

generating an alarm if it is determined that over power is outputted according to the monitoring result (S314);

turning off the RF switch for shutting off a reception path (S316); and

performing the initializing operation performed before the repeating apparatus is normally operated (S318).

As described above, the wireless repeating apparatus for a mobile communication system of the present invention has the following advantages.

First, the wireless repeating apparatus of the present invention can be additionally inserted into and installed within a conventional wireless repeating apparatus, thus reducing excessively high costs required to obtain separability between transmitting and receiving antennas necessary for a wireless repeating apparatus.

Second, the wireless repeating apparatus of the present invention can cover a large area because it enables the radiation of high power output signals.

That is, a problem of the conventional wireless repeating apparatus, namely, a problem that it cannot sufficiently radiate output signals of desired levels and it has a narrow coverage because it is difficult to obtain separability between transmitting and receiving antennas, can be solved. Therefore, the wireless repeating apparatus of the present invention can be used as substitution for an optical repeater. Further, the present invention can reduce costs for installation and maintenance of optical lines.

Third, the wireless repeating apparatus of the present invention can provide a wide-band repeating service, so it can be applied to a current cellular network, a personal communication system network, a wireless local loop (WLL) network, and a later IMT-2000 network, thus reducing operating costs of networks by reducing the number of base stations.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A repeating apparatus of a wide band mobile communication system, the repeating apparatus amplifying a wirelessly received signal and repeating the amplified signal at the same frequency as that of the received signal, comprising:
a transmission stage comprised of;
first specific tone generating means for generating a specific tone signal for a wireless repeating operation of a signal at the same frequency,
first amplifying means for amplifying the specific tone signal outputted from the first specific tone generating means,
first filtering means for filtering, duplexing and radiating the specific tone signal amplified by the first amplifying means, and
first phase and amplitude detecting means for detecting an amplitude and a phase variation of a signal radiated and induced by the first filtering means; and
a reception stage comprised of;
second filtering means for receiving, filtering and duplexing the specific tone signal radiated from the transmission stage,
second amplifying means for amplifying the specific tone signal outputted from the second filtering means,
second phase and amplitude detecting means for detecting an amplitude and a phase variation of the specific tone signal outputted from the second amplifying means,
phase and amplitude comparing means for comparing and detecting the phase and amplitude outputted from the first phase and amplitude detecting means with those outputted from the second phase and amplitude detecting means,
control means for controlling and transmitting information detected by the phase and amplitude comparing means,
amplitude and inverse phase summation means for summation amplitudes and inverse phases of the phase variations detected by the phase and amplitude comparing means under the control of the control means,
specific tone detecting means for detecting only a specific tone component detected by the second phase and amplitude detecting means, and
RF switching means for monitoring an output of power under the control of the control means, and shutting off a frequency path if the output of power greater than a predetermined level is detected.

2. The repeating apparatus according to claim 1, further comprising step attenuation and feedback path means for eliminating the specific tone signal by using correction values of an amplitude and a phase of a signal internally fed back through the first phase and amplitude detecting means and a feedback path.

3. The repeating apparatus according to claim 1 or 2, wherein the amplitude and inverse phase summation means comprises:
a N-stage divider for dividing the amplitude and the phase of a signal outputted from the step attenuation and feedback path means into N-stages;
a first stage amplitude and inverse phase summation unit for summation an amplitude and an inverse phase of the specific tone signal of a first stage divided by the N-stage divider;
a N-th stage amplitude and inverse phase summation unit for summation amplitudes and inverse phases of first to N-th stages divided by the N-stage divider; and
a N-stage phase summation unit for extracting and summation phases of a first stage and a N-th stage.
